(19) United States
(12) Patent Application Publication
(10) Pub. No.: US 2011/0112260 A1
(43) Pub. Date: May 12, 2011

(54) COMPOSITION COMPRISING A BLEND OF RESINS

(76) Inventors: Rudolfus Antonius Theodorus Maria Van Benthem, Limbricht (NL); Mark Martinus Maria Janssen, Ospel (NL); Jozef Johannes Catherina Jacobus Boonen, Grubbenvorst (NL)

(21) Appl. No.: 12/922,975

(22) PCT Filed: Mar. 18, 2009
(86) PCT No.: PCT/EP2009/053181

§ 371 Date: Dec. 20, 2010

(30) Foreign Application Priority Data
Mar. 18, 2008 (EP) 08005003.2

(51) Int. Cl. C08L 67/00; C08L 61/10

(52) U.S. Cl. 525/418

(57) ABSTRACT

A composition comprising a blend of phenol-formaldehyde resin and a phenol-glyoxylate resin wherein the blend has a pH of from 7 to 10. The resins may be used as binder adhesives for mineral wool insulation or in foundry applications.

The invention relates to a blend of phenol-formaldehyde (PF) resin and phenol-glyoxylate (PG) resin.

Phenol-formaldehyde resins are known. See for example A. Knop, L. A. Pilato, Phenolic Resins, Springer Verlag Berlin 1990. These resins have many known uses, such as for example the use of these resins in adhesives for the preparation of particle boards and in binder adhesives for mineral wool isolation products. A disadvantage of these resins is that their use is associated with possible health risks relating to the emission of formaldehyde during resin preparation, resin curing and in end products. Currently legislation is being enacted in several countries to limit the amount of formaldehyde that may be emitted from such resins.

Phenol-glyoxylate resins have been suggested as an alternative to PF resins. PG resins reduce or eliminate the formaldehyde from the product. See for example WO2006/059903, WO2007/140940, and WO2007/140941. While PG resins reduce the amount of formaldehyde that might devolve from the resin they can suffer from the disadvantage that they can be more expensive to produce and can require low resin pH for curing. The low pH may have undesirable effects on materials that are brought in contact with these resins, such as discoloration of wood or wood strands in wood-based panels or enhanced corrosion of steel manufacturing equipment in contact with these resins.

JP 51-97151 (Japan Synthetic Rubber) describes photo curable polymers having a repeat unit comprising a carboxylic acid moiety and an aromatic moiety (e.g. represented by Formula 5, paragraph 87). However the meaning of Formula 5 must be read and understood in the context of the complete text of this document, which teaches (paragraph 83) that a phenolic compound (such as phenol) is coupled with a glyoxylic acid (in a 2:1 ratio) to form a bis-phenolic compound as shown in Formula 4 (paragraph 84). The next step (paragraph 86) is a final poly-condensation step stated to produce resins of Formula 5 (paragraph 87). However this step does not use just bis-phenolic compound of Formula 4 alone. Instead compounds of Formula 4 also react with a resol resin (with phenol and formaldehyde as reactants) to build in a bis-phenolic structure into a larger polymer. The formaldehyde is necessary as auxiliary aldehyde to make a polymeric structure. So a skilled person reading the document would not understand Formula 5 to represent a polymer in an absolute sense where the polymer is built solely (or even substantially) from the repeat unit of Formula 5. A skilled person would appreciate that it is not the 2-oxoethanoic acid with the phenolic compound that gives rise to a polymer network described but the use of formaldehyde (from the resol resin). Thus it is implicit that the repeat units of Formula 5 must occur within the polymer network together with other repeat units. The process also has the disadvantage of using formaldehyde.

EP 0779355 (Lubrizol)) describes lubricants containing a salt additive formed by reacting an optionally hydrocarbyl substituted glyoxylic acid with a hydroxyl aromatic compound. The starting material described is a molecular adduct formed between two phenolic compounds and one molecular of aldehyde (comparable to a Bisphenol-A: product). This material is not a resin in the sense of a reactive polymer which can form a cured resin network. The final compounds described are liquids that comprising molecules of two adducts coupled by one diol, they are not polymer networks.

The present invention relates to the surprising finding that the deficiencies of prior art may be at least partly addressed by a blend comprising both PG and PF resins. In particular, blends of the two resins have reduced formaldehyde content and reduced formaldehyde emission, and also improved reactivity leading to faster curing times.

As used herein, “phenol-formaldehyde resin” refers to resins comprising phenol and/or phenolic compounds and formaldehyde as monomers. The term encompasses phenol-urea-formaldehyde resins which are resins comprising phenol and/or phenolic compounds, urea or ureic compounds, and formaldehyde as monomers, or blends of “phenol-formaldehyde resins” with “urea-formaldehyde resins”. As used herein, “urea-formaldehyde resin” refers to resins comprising urea and/or ureic compounds and formaldehyde as monomers. Phenolic compounds are for example resorcinol, cresol, natural lignines and tannins, and bisphenol-A. Ureic compounds are, for example, glycouril, guanamine, benzoguanamine, and melamine.

As used herein, “phenol-glyoxylate resin” refers to resins comprising phenol and/or phenolic compounds and glyoxylic acid and/or glyoxylic compounds as monomers. Glyoxylic compounds include glyoxylate esters or amides, and glyoxylate ester hemiacetals.

As used herein “curable resin” means a reactive polymer which can form a cured resin network. As used herein “heat curable resin’ means a resin that forms an insoluble, solid polymer network by itself on heating without the addition of other compounds.

For all upper and lower boundaries of any parameters herein, the boundary value is included and all combinations of boundary values may be used to define various preferred ranges.

Preferred PG resins used herein substantially comprises, more preferably consist of, phenolic and glyoxylic repeat units. Most preferably the PG resin used herein and/or composition of the invention are obtained without adding any aldehydes and/or resols in addition to phenolic and/or glyoxylic compounds.

The term “comprising” as used herein means that the list that immediately follows is non-exhaustive and may or may not include any other additional suitable items, for example one or more further feature(s), component(s), ingredient(s) and/or substituent(s) as appropriate. “Substantially comprising” as used herein means a component or list of component(s) is present in a given material in an amount greater than or equal to about 90%, preferably ≧95%, more preferably ≧98% by weight of the total amount of the given material. The term “consisting of” as used herein mean that the list that follows is exhaustive and does not include additional items.

For all upper and lower boundaries of any parameters given herein, the boundary value is included in each range for each parameter. All combinations of minimum and maximum values of the parameters described herein may be used to define the parameter ranges for various embodiments of the invention.

It will be understand that the sum of each parameter expressed herein as a percentage will total 100%, for example the amount of all the ingredients that comprise a composition of the invention (or part thereof) when expressed as a percentage of the composition (or the same part thereof) will total 100%.

Preferred compositions comprise greater than or equal to 10%, more preferably ≧20%, most preferably ≧50% of PF resin by weight of the composition.

Preferred compositions comprise greater than or equal to 1%, more preferably ≧10%, most preferably ≧20% of PF resin by weight of the composition.

Preferably the respective weight ratio of PG resin to PF resin is a ratio from 1 to 100 to a ratio of 1 to 1, more preferably a ratio of 1 to 50 to a ratio of 1 to 2, most preferably a ratio of 1 to 40 to a ratio of 1 to 5.

The pH of the blend composition (before cure) is from 7 to 10, preferably from 8 to 9.5, more preferably from 8.5 to 9.5.

While not wishing to be bound by theory it is believed that the PG components of the blend react more readily with the PF components than do the PG components among themselves, and that the formaldehyde-derived reactive groups of the PF components react with the phenolic and glyoxylic groups of the PG components. Typically PG resins have a pH of 1 to 4 and do not cure (i.e. react with themselves) at pH's above 5 so it is surprising that they can be successfully formulated at higher pH's thus avoiding the issues associated with low pH resin compositions discussed above. In certain embodiments the present blends also cure relatively rapidly and show a surprising reduction in formaldehyde emission.

Any suitable PF resin may be used herein. Suitable PF resins are described in e.g. A. Knop, L. A. Pilato, Phenolic Resins, Springer Verlag Berlin 1990. Suitable PF resins include for example resol resins (having a molar ratio of formaldehyde of higher than 1), novolac resins (having a molar ratio of formaldehyde of smaller than 1, to which crosslinker has been added such as hexamethylene tetramine), and modified phenolic resins. Preferred PF resins include urea modified phenolic resins, more preferably urea modified phenolic resins with a urea content of between 30 and 40%. An example of a preferred PF resin is BAKELITE® PF 1764 M, which is used in the manufacturing of mineral wool insulation materials.

Any suitable PG resin may be used herein. Preferred PG resins are selected from those disclosed in WO2006/059903, WO2007/140940, and WO2007/140941.

Preferred PG compounds herein include resins obtained and/or obtainable from phenolic monomers and glyoxylic acid and/or glyoxylic ester monomers. Conveniently the respective molar ratio of glyoxylic (acid/ester) to phenol is a ratio from 0.5 to 1 to a ratio of 3 to 1, more conveniently a ratio from 0.6 to 1 to a ratio of 2 to 1, most conveniently a ratio from 1 to 1 to a ratio of 1.5 to 1. Usefully PG compounds according to the invention are resins that are obtained from the monomers glyoxylic acid and phenol, where the respective molar ratio of the monomers is a ratio from 1 to 1 to a ratio of 1.5 to 1.

According to another preferred embodiment of the invention, the PG resin is also obtained or obtainable from a polyol component where the polyol component is present in an amount so the respective molar ratio of OH groups on the polyol to COOH groups on the PG resin is a ratio from 0.01 to 1 to a ratio of 1 to 1, more preferably a ratio from 0.1 to 1 to a ratio of 0.8 to 1. Preferred polyols are pentaerythritol, ethylene glycol, diethylene glycol, triethylene glycol and/or glycerol.

Preferably the PG resin is prepared from a hydroxy-aromatic compound according to formula (I):

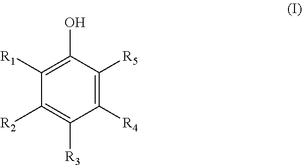

wherein:
at least one of the set consisting of R₁, R₃, and R₅ is a group of formula (II); any remaining one or two of the set consisting of R₁, R₃, and R₅ being H, OH, a C₁-C₁₂ alkyl group or an oligomeric or polymeric system;
R₂ and R₄ are H, OH, a C₁-C₁₂ alkyl group, or an oligomeric or polymeric system;

Formula (II) is the following group:

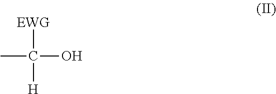

wherein EWG is an electron-withdrawing group.

As is known in hydroxy-aromatic chemistry, the positions on the aromatic ring adjacent to and opposite the hydroxy group (i.e., ortho and para) have a different reactivity than the remaining two meta-positions. In formula (I), therefore, the groups R₁, R₃, and R₅ could be regarded within a similar context and are herein referred to as a set.

In the present PG compound, at least one of the groups in the set consisting of R₁, R₃, and R₅ is a group according to formula (II); the other one or two groups in the said set—in case not all three of the said set is a group according to formula (II)—is/are H, OH, or C₁-C₁₂ alkyl group, preferably H, OH, a C₁-C₉ alkyl group, or an oligomeric or polymeric system. If there are two groups not according to formula (II) then they may be the same or may be different. The oligomeric or polymeric system may be a hydroxy-aromatic resin, either of the resol or of the novolac type, preferably of the novolac type; or it may be a different type of thermosetting or thermoplastic system. For example, the set according to R₁, R₃, and R₅ consist of: R₁ is a group according to formula (II), R₃ is H, and R₅ is H; R₁ is a group according to formula (II), R₃ is H, and R₅ is CH₃; R₁ is H, R₃ is a group according to formula (II), and R₅ is H; R₁ and R₃ are a group according to formula (II), R₅ is H; R₁, R₃, and R₅ are all a group according to formula (II).

In the present PG compound, R₂ and R₄ are H, OH, a C₁-C₁₂ alkyl group, or an oligomeric or polymeric system; preferably R₂ and R₄ are H, OH or a C₁-C₉ alkyl group. R₂ and R₄ may be the same or may be different. Some preferred embodiments of R₂ and R₄ are: R₂ is OH and R₄ is H; R₂ is CH₃ and R₄ is H; R₂ is CH₃ and R₄ is CH₃; R₂ is H and R₄ is C₄H₉. R₁ and R₂ may be part of a multicyclic compound; the same holds mutatis mutandis for R₂ and R₃, R₃ and R₄, or R₄ and R₅.

The group according to formula (II) is an integral part of the compound; it is either R₁, R₃, or R₅ in formula (I), or two of those, or all three. In formula (II), EWG is an electron-withdrawing group. EWG's are as such known to the skilled person. Examples of an EWG are acid-, ester-, cyano-, di-alkylacetal-, aldehyde-, substituted phenyl-, or trihalomethyl groups. Hydrogen is not an EWG. In a preferred embodiment, the group of formula (II) is a group according to formula (III):

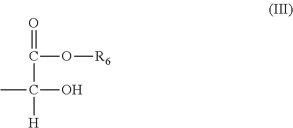

wherein R₆ is H, a C₁-C₁₂ alkyl group, aryl group, aralkyl group or cycloalkyl group. Preferably R₆ is H or a C₁-C₁₂ alkyl group; examples hereof are methyl, ethyl, propyl, butyl, pentyl, hexyl; more preferably, R₆ is H, a methyl group or an ethyl group.

In a preferred embodiment of the present PG compound, at least one of the set consisting of R₁, R₃, and R₅ is H. This has the advantage that the hydroxy-aromatic compound is better suitable for the preparation of the oligomeric or polymeric structures typical for resins. In another preferred embodiment, two of the set consisting of R₁, R₃, and R₅ are H. This has the advantage that such a compound can be used to create three-dimensional networks, an ability often desired in resins. The same ability of the compound to create three-dimensional networks is present in those embodiments where all of R₁, R₃, and R₅ are either H or a group according to formula (II).

The compound as described above may be prepared by bringing a compound of formula (IV) into contact with a compound according to formula (V), optionally in the presence of a catalyst, and allowing them to react whereby formula (IV) is:

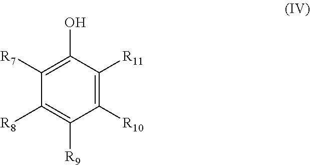

wherein R₇, R₈, R₉, R₁₀ and R₁₁ are H, OH, a C₁-C₁₂ alkyl group or an oligomeric or polymeric system, whereby at least one and preferably two or even three of the set consisting of R₇, R₉, and R₁₁ is or are H; and formula (V) is:

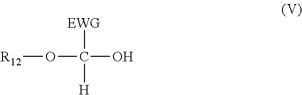

wherein EWG is an electron-withdrawing group and wherein R₁₂ is H, a C₁-C₁₂ alkyl group, aryl group, aralkyl group or cycloalkyl group.

In another preferred embodiment, the compound according to formula (V) is an alkanol hemiacetal according to formula (VI):

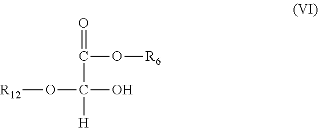

wherein R₆ is H or a C₁-C₁₂ alkyl group, aryl group, aralkyl group or cycloalkyl group and wherein R₁₂ is H, a C₁-C₁₂ alkyl group, aryl group, aralkyl group or cycloalkyl group. Preferably R₆ and R₁₂ are C₁-C₁₂ alkyl groups. Examples thereof are methyl, ethyl, propyl, butyl, pentyl, hexyl, and heptyl. R₆ and R₁₂ are in particular a methyl group or an ethyl group.

Examples of preferred compounds according to formula (IV) are phenol, (2, 3, or 4-)cresol, resorcinol, (2, 3, or 4-)tert-butylphenol, (2, 3, or 4-)nonylphenol, (2,3-2,4- 2,5- 2,6- or 3,4-)dimethylphenol, (2, 3, or 4-)ethylphenol, bisphenol A, bishenol F, and hydrochinon. Examples of compounds according to formula (V), in particular of the preferred alkanol hemiacetals according to formula (VI), are methylglyoxylate methanol hemiacetal (GMHA™, DSM Fine Chemicals, Linz); ethylglyoxylate ethanol hemiacetal (GEHA™, DSM Fine Chemicals, Linz); ethylglyoxylate methanol hemiacetal; butylglyoxylate butanol hemiacetal; butylglyoxylate methanol hemiacetal; butylglyoxylate ethanol hemiacetal; isopropylglyoxylate isopropanol hemiacetal; propylglyoxylate propanol hemiacetal; cyclohexylglyoxylate methanol hemiacetal, 2-ethylhexylglyoxylate methanol hemiacetal, and combinations thereof.

Further examples of compounds suitable for reacting with the compounds of Formula (I) are oxoethanoic acid (glyoxylic acid hydrate), methylglyoxylate hydrate, ethylglyoxylate hydrate, and combinations thereof.

Preferred compounds for reacting with the compounds of Formula (I) include oxoethanoic acid, methylglyoxylate methanol hemiacetal, ethylglyoxylate ethanol hemiacetal, and combinations thereof.

It may be beneficial to execute the reaction step according to the invention in a solvent or dispersant. As solvents, those compounds are suitable in which the reactants dissolve sufficiently to let the reaction take place. Examples of such solvents are water and various organic solvents. Depending on the specific compound or compounds of formula (IV) and (V), it may well be possible to use one or more of the reactants as solvent; in such a case, it can be possible to forego on the use of a solvent that is essentially a non-reactant and to execute the reaction step in bulk. In particular, many of the compounds according to formula (V) and in particular according to formula (VI) are a liquid at temperatures between 10° C. and 100° C. and can act as dispersant/solvent as well as reactant.

Although the reaction step may proceed spontaneously once the respective compounds have been brought together, it may be useful to bring the compounds together in the presence of a catalyst in order to accelerate the reaction. As catalyst, preferably an acid or a base is used; in particular, a Lewis or a Brønsted type of acid is preferred—such as for example sulphuric acid—whereby the pH is reduced to between 0 and 5, preferably to between 1 and 4, in particular to between 2 and 3. Suitable examples of acid catalysts are sulphuric acid, methanesulfonic acid, nitric acid, hydrochloric acid, phosphoric acid, boric acid, tetrafluoroboric acid, paratoluene sulphonic acid, formic acid, ammonium sulphate, ammonium chloride, ammonium nitrate. Suitable examples of basic catalysts are ammonia, trimethyl amine, triethyl amine, DABCO (diaza-bicyclo-octane), DBU (diaza-bicyclo-undecene), DMAP (4-dimethylaminopyridine), sodium hydroxide, potassium hydroxide.

The temperature in the reaction step of present process can vary within wide limits, and preferably lies between 10° C. and 100° C. More preferably the process is carried out at between 40° C. and 90° C. The pressure in the present process preferably is between 0.005 MPa and 1.0 MPa, preferably between 0.02 MPa and 0.2 MPa; most preferably, the pressure is atmospheric.

As consequence of the reaction step, a compound according to formula (I) is formed; additionally, other compounds may released as by-products. It may be desirable to isolate such compound according to formula (I); this may be achieved through techniques that are as such known, such as for example a combination of pH change, solvent exchange, evaporation and/or precipitation. If the compound according to formula (I) is not isolated, it may still be desirable to remove R₁₂OH; this may be achieved through techniques that are as such known, such as for example distillation. It may, however, also be acceptable or even desirable to let R₁₂OH remain in the presence of the compound according to formula (I).

In the process for the preparation of the hydroxy-aromatic compound according to the invention, the molar ratio between the EWG-containing compound according to formula (V) (E) and the hydroxy-aromatic compound according to formula (IV) (H), herein referred to as E/H ratio, may vary between wide limits. Preferably, the E/H ratio lies between about 0.1 and about 10, more preferably between about 0.5 and about 3. If the E/H ratio is about 0.5 or lower, the resulting hydroxy-aromatic compound according to the invention can be a mixture having a significant amount of a compound according to formula (I) in which one of the set consisting of R₁, R₃, and R₅ is a group of formula (II). If the E/H ratio is about 3 or higher, the resulting hydroxy-aromatic compound according to the invention can be a mixture having a significant amount of a compound according to formula (I) in which all three of the set consisting of R₁, R₃, and R₅ are a group of formula (II). If the E/H ratio is about 1 or 2, the resulting hydroxy-aromatic compound according to the invention can be a mixture in which compounds according to formula (I) in which one, two or all three of the set consisting of R₁, R₃, and R₅ are a group of formula (II) are all clearly represented.

When executing the reaction step as described above, it was found that a further reaction can also be made to take place, namely the formation of a compound according to formula VII:

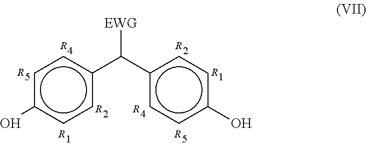

In case the EWG is according to formula (VI), the compound according to (VII) will be as in formula (VIII):

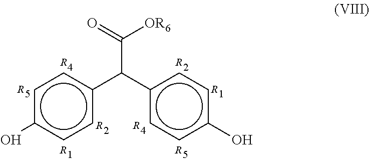

It was found that when executing the reaction step according to the invention, many hydroxy-aromatic compounds have a preference to first react on the para location of the aromatic moiety before doing so on the ortho location; hence the creation of compounds according to formula (VII) or (VIII). The present invention therefore also relates to compounds of formula (VII), in particular of formula (VIII), most preferably with R₁, R₂, R₄ and R₅ being all H and R₆ being methyl.

The compounds according to formula (VII) and (VIII) can typically be made by prolonged execution of the reaction step as described above for the preparation of compounds according to formula (I), whereby the E/H molar ratio preferably lies between 0.3 and 0.7, more preferably between 0.4 and 0.6.

Alternatively, using oxoethanoic acid as the preferred compound according to Formula V, and an E/H molar ratio of between 0.8 and 2.0, preferably between 1.0 and 1.5, compounds according to formula IX and formula X are typically formed after prolonged reaction time.

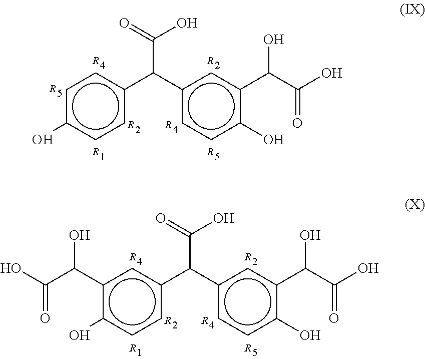

The PG resins herein may be prepared via condensation reactions between a hydroxy-aromatic compound and a compound such as an aldehyde, and typically also subsequent condensation reactions; an example of such a process is the process for preparation of a phenol-formaldehyde resin. In the process according to the invention, a compound according to formula (I) is used in the (subsequent) condensation reactions. The (subsequent) condensation reactions may be executed in the same fashion and under similar conditions as described above for the preparation of the compound according to formula (I), (VII) (VIII), (IX) and (X), although typically for a—further—prolonged period of time. The compound falling within the scope of formula (V) and in particular formula (VI) may be—aside from the hydroxy-aromatic compound according to formula (I) and/or the already formed oligomeric or polymeric structures—the sole other compound participating in the condensation reactions in the resin; it may also be possible to use other compounds such as aldehdyes like formaldehyde or furfural (C₅H₄O₂) in combination with the compound according to formula (V). Preferably, however, at least 5 or 10 mol. % of the compounds participating in the condensation reactions with a hydroxy-aromatic moiety in the resin are one or more compounds according to formula (V); more preferably, this is at least 20 or 30%; in particular, this is at least 40 or 50%; with strong preference, at least 60 or 70 mol. % of the compounds reacting with a hydroxy-aromatic moiety in the resin are one or more compounds according to formula (V); most preferably, this is at least 80 or 90% or even essentially 100%.

The PG resin comprises hydroxy-aromatic moieties (H) derived from hydroxy-aromatic compounds used as starting materials. The resin also comprises EWG-derived moieties and possibly aldehyde-derived moieties, together referred to as A. The resin thus has a molar A/H ratio. The molar A/H ratio in the resin preferably lies between 0.5 and 3, more preferably between 0.75 and 2. If the molar A/H ratio lies above 1, resol-type of resins can be formed whereby reactive ‘A’-derived hydroxy groups are available. If the molar A/H ratio lies below 1, novolac-type of resins can be formed, in which essentially all ‘A’-derived hydroxyl functionality has reacted away to form C—C and C—O ether bonds.

According to an embodiment of the invention, a hydroxy-aromatic resin can be prepared directly from raw materials comprising a compound according to formula (IV) as hydroxy-aromatic compound, and a compound according to formula (V). The conditions for achieving this are similar to those given above for the process or preparing the compound according to formula (I), and can be established by the skilled person via simple routine experimentation and using also his knowledge of the preparation of phenol-formaldehyde resins.

The preparation of a blend according to the invention may be effected by mixing at ambient temperature the PF resin and the PG resin, and consecutively adjusting the pH to 7-10. Adjustment of the pH may, for example, be effected by adding a base. Examples of suitable bases include metal hydroxides, metal carbonates and amines. Examples of suitable hydroxides are potassium hydroxide, sodium hydroxide, potassium carbonate, potassium bicarbonate, sodium carbonate, sodium bicarbonate. Examples of suitable amines are ammonia, ethanolamine, diethanolamine, triethanolamine, 2-dimethylamino-ethanol, triethylamine. Preferred bases are sodium hydroxide. and potassium hydroxide.

The invention moreover relates to the use of the present blends of PG and PF for the preparation of coatings, adhesives or shaped articles such as wood-based panels like particle boards, strand boards, plywood and laminates, or mineral wool such as stone wool or glass wool, or shaped textile articles such as automotive interior parts, or in the foundry industry. To this end, the resins may be used by methods and under conditions similar to those known per se for phenol-formaldehyde resins.

A catalyst and other additives may be added to the resin before the resin is used for processing in its final application. Examples of customary additives include mould release agents, antistatic agents, adhesion promoters, plasticizers, colour enhancing agents, flame retardants, fillers, flow promoters, colorants, diluents, polymerization initiators, UV-stabilizers, heat stabilizers, and combinations thereof. Examples of fillers include glass fibres, mica, carbon fibres, metal fibres, clay, aramide fibres, polyethylene fibres, and combinations thereof.

The resin according to the invention may be used as such; however, it is also possible to subject the resin to a modification step; this is a reaction step designed to alter or enhance its functionality in a specific way. An example of an altered functionality is the solubility of the resin in water. An example of an enhanced functionality is the addition of a reactive group. An example of a modification step is to bring the resin in contact with compounds that react with the —OH groups; an example of such a compound is epichlorohydrin. Another example of a modification step is to bring the resin in contact with compounds that hydrolyze the ester groups; an example of such a compound is water; the hydrolysis of ester groups into a —COOH group increases the solubility of the resin in water. Also, the modification step may be achieved through a transesterification reaction between the —OR₆ groups and suitable compounds such as amines.

Further aspects of the invention and preferred features thereof are given in the claims.

The present invention is illustrated with the following examples, which are non-limiting.

### EXAMPLE 1

104 g phenol (90 wt % in H₂O; 1 mol) and 252 g glyoxylic acid (40 wt % in H₂O; 1.4 mol) was placed in a 500 ml 3-necked round bottom flask equipped with a condenser. At a temperature of 80° C., 4 g methane sulphonic acid was slowly added to the reaction mixture. The temperature increases and is maintained at approximately 100° C. (reflux). After 8 hours reaction time the reaction was stopped by cooling the reaction mixture to room temperature. After cooling a light viscous resin is obtained with a pH of 1.5.

The resin is evaluated on strength by producing sandbars and determining the 3-point bending strength.

Sand with size between 0.25 and 0.6 mm is used to produce sandbars with dimensions 140 mm*25 mm*10 mm. For the making of 8 sandbars the procedure is as following: 500 g sand was mixed with 100 ml 15 wt % in water resin mixture. This mixture is poured into a mould. The sandbars are cured at approx 160° C. for 2 hours.

The bending strength was determined by breaking the bars in a measuring device which had a support span of 100 mm and a velocity of compressing of 10 mm/min after a preload of 0.2 N is applied.

34.4 g H₂O is added to 15.6 of this resin and stirred to a homogeneous mixture (pH 2.0). 250 g sand (sufficient for 4 sandbars) is added to the mixture and evaluated in the sandbar test. The average weight of the sandbars is 54.2 g and the average bending strength is 0.3 N/mm².

The resin is evaluated on reactivity by measuring the time to gelation at 130° C. The geltime for the PG-resin is 4 minutes.

A PF resin, BAKELITE® PF 1764 M, was tested likewise. The average weight of the sandbars is 58.3 g and the average bending strength is 2.9 N/mm². The geltime of this PF resin is 6 minutes. The formaldehyde emission level of cured resin powder may determined by placing the powder in an open Petri dish over a water container in a desiccator, and measuring by quantitative HPLC the amount of formaldehyde take up in the water after an exposure time of 24 h at room temperature.

1.5 g of the PG resin as prepared above, 15 g PF resin and 1.0 g NaOH (20 wt % in H₂O) are stirred until a homogeneous mixture having a pH of 9.4 was obtained. 16.3 g H₂O was added to 8.7 g of this mixture and stirred until a homogeneous mixture was obtained (mixture 2). 125 g sand (sufficient for 2 sandbars) was added to mixture 2 and evaluated as described above. The average weight of the sandbars was 52.3 g and the average bending strength was 2.3 N/mm². The geltime of the blend was 5 minutes, which is significantly shorter than that of typical PUF resins, taking into account that the water evaporation preceding the gel formation takes around 3 minutes. The formaldehyde emission of cured resin blend powder may be reduced compared to a typical PUF resin.

### EXAMPLE 2

3 g of the PG resin described in Example 1, 15 g PF resin (BAKELITE® PF 1764 M) and 2.5 g NaOH (20 wt % in H₂O) were stirred until a homogeneous mixture was obtained (pH 9.3). 16.3 g H₂O was added to 8.7 g of this mixture and stirred until homogeneous. 125 g sand (sufficient for 2 sandbars) was added to the mixture and evaluated as described in example 1. The average weight of the sandbars was 52.8 g and the average bending strength was 2.0 N/mm². The geltime determined for this resin blend was 5 minutes which is significantly shorter than that of typical PUF resins. The formaldehyde emission of cured resin blend powder may be reduced compared to a typical PUF resin.

### EXAMPLE 3

104 g phenol (90 wt % in H₂O; 1 mol) and 252 g glyoxylic acid (40 wt % in H₂O; 1.4 mol) was placed in a 500 ml 3-necked round bottom flask equipped with a condenser. At a temperature of 80° C., 4 g methane sulphonic acid is slowly added to the reaction mixture. Temperature increased and was maintained at approximately 100° C. (reflux). After 2 hours reaction time 57 g pentaerythritol was added to the mixture and dissolved. After dissolving the pentaerythritol in the reaction mixture the reaction was stopped by cooling down to room temperature. After cooling down a light viscous resin was obtained (pH 1.5).

35.6 g H₂O was added to 14.4 g of the resin and stirred until a homogeneous mixture was obtained. 250 g sand (sufficient for 4 sandbars) was added to this mixture and evaluated as described in Example 1. The average weight of the sandbars was 53.3 g and the average bending strength was 2.3 N/mm².

The geltime for this resin was 4 minutes.

4.5 g resin as described above, 15 g PF resin (BAKELITE® PF 1764 M) and 2.5 g NaOH (20 wt % in H₂O) are stirred until a homogeneous mixture was obtained. The pH was 9.3. 16.2 g H₂O was added to 8.8 g of this mixture and stirred until homogeneous. 125 g sand (sufficient for 2 sandbars) was added to the mixture and evaluated as described in Example 1. The average weight of the sandbars was 54.5 g and the average bending strength was 2.0 N/mm².

### EXAMPLE 4

52 g phenol (90 wt % in H₂O; 0.5 mol) and 92.5 g glyoxylic acid (40 wt % in H₂O; 0.5 mol) was placed in a 250 ml 3-necked round bottom flask equipped with a condenser. 1 ml concentrated H₂SO₄ was slowly added to the reaction mixture. Temperature increased and was maintained at approximately 100° C. (reflux). After 9 hours reaction time the reaction was stopped by cooling the reaction mixture to room temperature. After cooling down a light viscous resin was obtained.

4.5 g resin like described in example 4, 15 g PF resin (BAKELITE® PF 1764 M) and 3.8 g NaOH (20 wt % in H₂O) were stirred until a homogeneous mixture was obtained. The pH was 9.4. 16.1 g H₂O was added to 8.9 g of this mixture and stirred until a homogeneous mixture was obtained. The average weight of sandbars prepared from this resin blend was 54.2 g and the average bending strength was 1.9 N/mm². The geltime of this blend was 5 minutes.

### COMPARATIVE EXAMPLES

1 g of the PG resin prepared in example 3, together with 10 g PF resin (BAKELITE® PF 1764 M) were stirred until a homogeneous mixture was obtained. The pH was determined to be 4.9. Without adjustment of the pH, 17.5 g H₂O was added to 7.5 g of this mixture and stirred until a homogeneous mixture was obtained. No sandbars of coherent strength could be prepared, the sandbars were easily broken across when removed from the mould.

3 g of the PG resin prepared in example 1, together with 10 g PF resin (BAKELITE® PF 1764 M) were stirred until a homogeneous mixture was obtained. The pH was determined to be 4.0. Without adjustment of the pH, 17.5 g H₂O was added to 7.5 g of this mixture and stirred until a homogeneous mixture was obtained. No sandbars of coherent strength could be prepared, the sandbars were easily broken across when removed from the mould.

3 g of the PG resin prepared in example 1, together with 10 g PF resin (BAKELITE® PF 1764 M) were stirred until a homogeneous mixture was obtained. The pH was determined to be 4.0. After adjustment of the pH to 2.0 using methane sulfonic acid, the resin was not stable at room temperature and formed a yellowish opaque dispersion within minutes, and no sandbars of coherent strength could be prepared.

1. A composition comprising a blend of phenol-formaldehyde resin and a phenol-glyoxylate resin wherein the blend has a pH of from 7 to 10.

2. A composition according to claim 1 wherein the pH is from 8 to 9.5.

3. A composition according to claim 1 wherein the ratio of phenol-glyoxylate resin to phenol-formaldehyde resin in the blend is a ratio from 1 to 100 to a ratio of 1 to 1.

4. A blend according to claim 1 wherein the ratio of phenol-glyoxylate resin to phenol-formaldehyde resin in the blend is a ratio from to 1 to 40 to a ratio of 1 to 5.

5. A composition according to claim 1 wherein the phenol-formaldehyde resin is selected from urea modified phenolic resins.

6. A composition according to claim 1 wherein phenol-glyoxylate resin comprises the reaction product of a hydroxy-aromatic compound of formula (I): 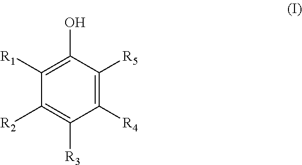
wherein:
at least one of the set consisting of R₁, R₃, and R₅ is a group of formula (II); any remaining one or two of the set consisting of R₁, R₃, and R₅ being H, OH, a C₁-C₁₂ alkyl group or an oligomeric or polymeric system;
R₂ and R₄ are H, OH, a C₁-C₁₂ alkyl group or an oligomeric or polymeric system;
and a compound according to formula (II): 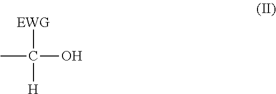
wherein EWG is an electron-withdrawing group.

7. A composition according to claim 5 wherein the compound according to formula (II) is selected from oxoethanoic acid, methylglyoxylate methanol hemiacetal, ethylglyoxylate ethanol hemiacetal, and combinations thereof.

8. A composition according to claim 1 wherein the phenol-glyoxylate resin comprises the reaction product of phenol and oxoethanoic acid.

9. An article comprising a composition according to claim 1.

10. Use of a composition according to claim 1 to produce mineral wool.

11. Use of a composition according to claim 1 in foundry applications.
